(19) United States
(12) Patent Application Publication
(10) Pub. No.: US 2004/0029471 A1
(43) Pub. Date: Feb. 12, 2004

(54) Method for graphitising a carbonised fabric

(76) Inventors: Birgit Severich, Viernheim (DE); Gerhard Schoepping, Hemsbach (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/432,501

(22) PCT Filed: Jul. 21, 2001
(86) PCT No.: PCT/EP01/08451

(30) Foreign Application Priority Data
Nov. 21, 2000 (DE) 100 57 867.5

(51) Int. Cl. C01B 31/04

(52) U.S. Cl. 442/117; 423/448

(57) ABSTRACT

The invention relates to a method for graphitising a carbonised fabric. According to said method, the carbonised fabric is heated to temperatures of between 1,200° C. and 3,200° C. in lines or columns, by means of a laser beam, with admission of air.

The present invention relates to a method for graphitizing a carbonized fabric.

Japanese Patent Documents JP 2139464, JP 06123050 and JP 11158737 describe methods for manufacturing nonwoven carbon fiber fabrics, in which a nonwoven fabric of organic, flame-resistant fibers, such as preoxidized polyacrylonitrile fibers or pitch fibers, is converted into a conductive, graphitized nonwoven fabric by heating to temperatures ≧1,100° C. in an inert gas atmosphere.

Moreover, United States Patent U.S. Pat. No. 3,699,210 describes a method for graphitizing fibers or nonwoven fabrics, in which precursor fibers composed of polyacrylonitrile polymers or aromatic polyamides are heated to 180° C. to 550° C. in an oxygen-containing atmosphere and thereafter heated by a CO₂ laser beam, initially to 700° C. to 1,200° C. and then to 1,200° C. to 3,600° C., and converted into graphitized fibers. To this end, the yarn or nonwoven fabric to be graphitized must be introduced into an inert gas atmosphere. Such measures make the production process more expensive and slow it down.

The object of the present invention is to provide a simplified method for manufacturing graphitized fabrics.

This objective is achieved according to the present invention in that the carbonized fabric is heated by a laser beam to temperatures of between 1,200° C. and 3,200° C. in lines or columns, while admitting air.

Surprisingly, it was discovered that the heating can be done using a laser beam and in the presence of air, without destroying the fabric, i.e., burning the fibers. This greatly simplifies the method, because devices for the supply of inert gas are no longer needed, which allows the method to be carried out in a simple and continuous manner, obtaining an electrically conductive product.

Preferably, the process power of the laser beam is at least 5.0 kWs g⁻¹.

The process power used ensures conversion of the starting fibers into graphitized fibers without burning them.

Preferably, the heating is accomplished with the aid of a CO₂ laser. The CO₂ laser allows very fast and continuous supply of energy. In an advantageous embodiment of the method according to the present invention, graphitizing is done in such a way that only conductive track-like structures are graphitized. In this manner, electrically conductive structures are made available on the inherently non-conductive starting nonwoven fabric, opening new fields of application.

The present invention further relates to a graphitized nonwoven fabric that is made according to the inventive method and used as a gas-distribution layer in fuel cells.

Moreover, the present invention relates to a graphitized nonwoven fabric that is used as a base material for electrodes in supercapacitors.

The graphitized fabric according to the present invention has sufficient mechanical strength, ensuring handling of the graphitized fabric. Compared to the graphitized fabrics produced using the conventional method, the stiffness of the graphitized fabric according to the present invention is markedly increased without making the material brittle.

The present invention further relates to a graphitized nonwoven fabric which is used as a conductive lining fabric for electrically connecting electronic devices embedded in a garment, as an antenna for electronic devices and/or as a heating conductor in garments.

The present invention is explained in greater detail by the examples below.

### EXAMPLE 1

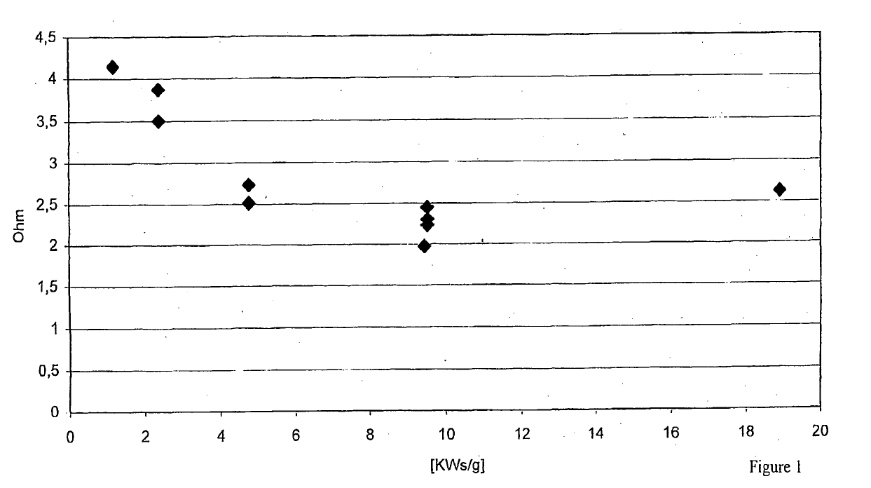

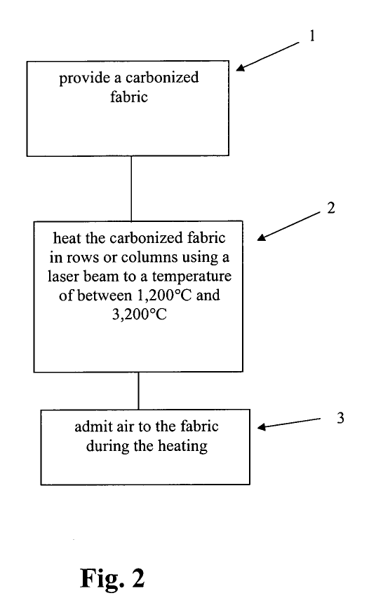

Carbonized nonwoven fabrics of preoxidized polyacrylonitrile fibers having a weight per unit area of 60 g/m2 were graphitized using a CO₂ laser having a continuous power of about 1,000 W at a feed rate of 6 mm in the machine direction and a laser beam diameter of 14 mm. FIG. 1 shows the dependence of the conductivity on the laser process energy used.

What is claimed is:

1. A method for graphitizing a carbonized fabric,
wherein the carbonized fabric is heated by a laser beam to temperatures of between 1,200° C. and 3,200° C. in lines or columns, while admitting air.

2. The method as recited in claim 1,
wherein the process power is at least 5.0 kWs g⁻¹.

3. The method as recited in claim 1 or 2,
wherein the heating is accomplished with the aid of a CO₂ laser.

4. The method as recited in one of the claims 1 through 3,
wherein only conductive track-like structures are graphitized.

5. A carbonized nonwoven fabric manufactured according to one or more of the claims 1 through 3,
characterized by its use as a gas-distribution layer in fuel cells.

6. A carbonized nonwoven fabric manufactured according to one or more of the claims 1 through 3,
characterized by its use as a base material for electrodes in supercapacitors.

7. A carbonized nonwoven fabric manufactured according to claim 4,
characterized by its use as a conductive lining fabric for electrically connecting electronic devices embedded in a garment, as an antenna for electronic devices and/or as a heating conductor in garments.
